(19) United States
(12) Patent Application Publication
(10) Pub. No.: US 2003/0021644 A1
(43) Pub. Date: Jan. 30, 2003

(54) Retractable bench assembly for drilling machine

(76) Inventor: Ruey-Zon Chen, Taichung Hsien (TW)

Correspondence Address: BACON & THOMAS, PLLC, 4th Floor, 625 Slaters Lane, Alexandria, VA, 22314, US

(21) Appl. No.: 09/912,528

(22) Filed: Jul. 26, 2001

(51) Int. Cl. B23B 39/00

(52) U.S. Cl. 408/87; 408/103

(57) ABSTRACT

An auxiliary bench is retractably connected to an underside of a main bench and includes two rods and a handle. The main bench has tow recesses defined in a peripheral flange thereof and the two rods are engaged with the two recesses. A retaining member is connected to an underside of the main bench by a lock member and has two grooves in which the two rods are movably received. The auxiliary bench is pulled to support long object to be drilled.

### FIELD OF THE INVENTION

The present invention relates to a drilling machine that has a retractable support bench which can be pulled out from a side of the main bench to support a long object to be drilled.

### BACKGROUND OF THE INVENTION

A conventional drilling machine is shown in FIG. 1 and generally includes a post 10 with a base 11 on a lower end and a motor casing 12 connected on a top end of the post 10. A chuck 120 is movably connected to the motor casing 12 and which is moved downward by rotating a handle 121 on a side of the motor casing 12. A bench 13 is connected to the post 10 so that the object to be drilled can be put on the bench 13. However, if the object is too long, the user has to hold the object during operating drilling process and it is impossible to hold the object firmly during the drilling. Besides, if the object is heavy, the user cannot hold it and has to use some support devices to support the object. Because the height of the bench 13 is adjusted according to the practical situation, the support devices have to meet the height of the bench.

The present invention intends to provide a support bench that is retractably connected to an underside of the main bench of the drilling machine.

### SUMMARY OF THE INVENTION

In accordance with one aspect of the present invention, there is provided a bench assembly for drilling machines and the assembly comprises a main bench connected to a post of a drilling machine and a peripheral flange extends from the main bench. Two recesses are defined in the peripheral flange and a retaining member is connected to an underside of the main bench. The retaining member has two grooves defined therein. An auxiliary bench comprises two rods which are engaged with the two recesses in the peripheral flange and movably received in the two grooves in the retaining member. A handle is connected to the two rods.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional bench on a drilling machine;

FIG. 2 is an exploded view to show a bench assembly of the present invention and a drilling machine;

FIG. 3 is an exploded view to show a bench assembly of the present invention;

FIG. 4 is a cross sectional view to show the connection between the rod and the handle;

FIG. 5 is a cross sectional view to show an end member is connected to the rod;

FIG. 6 is a cross sectional view to show the retaining member is connected to the main bench by a bolt;

FIG. 7 is a cross sectional view to show the rods are pulled out from the underside of the main bench;

FIG. 8 is a side view to show the bench assembly of the present invention and a drilling machine, and

FIG. 9 is a perspective view to show the bench assembly of the present invention and a drilling machine.

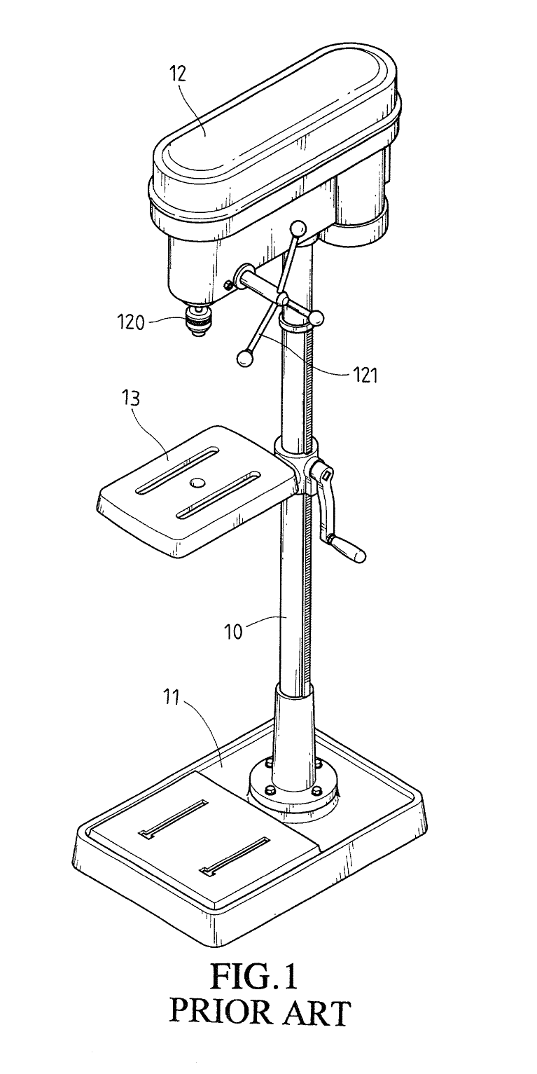

### DETAILED DESCRIPTION OF THE PREFERRED EMBODIMENT

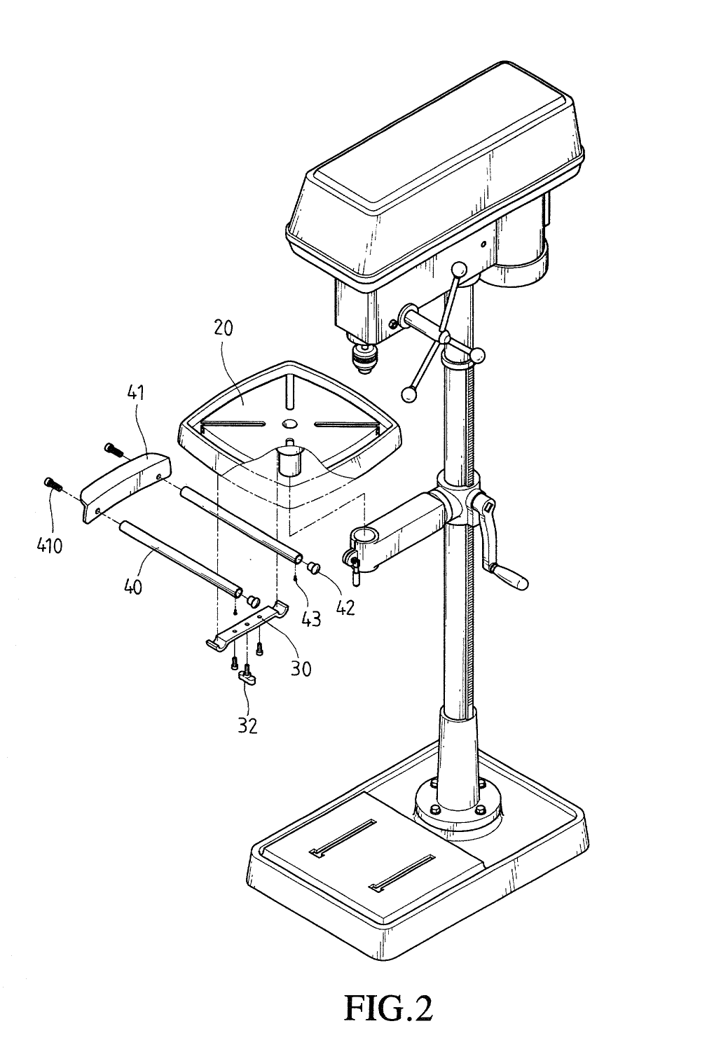

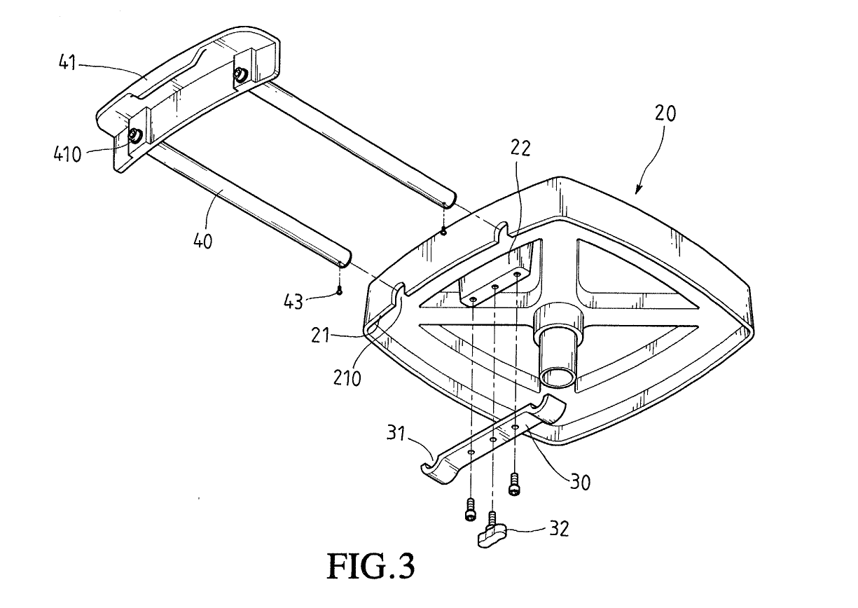

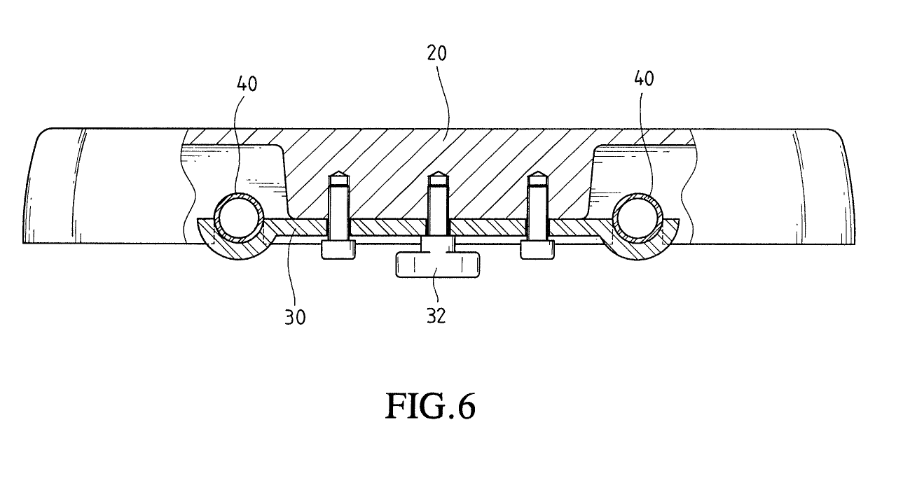

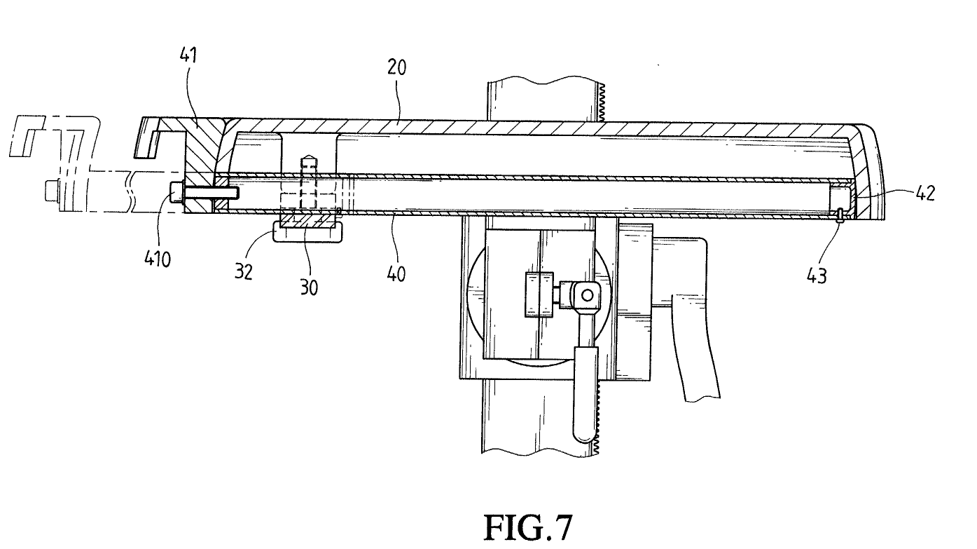

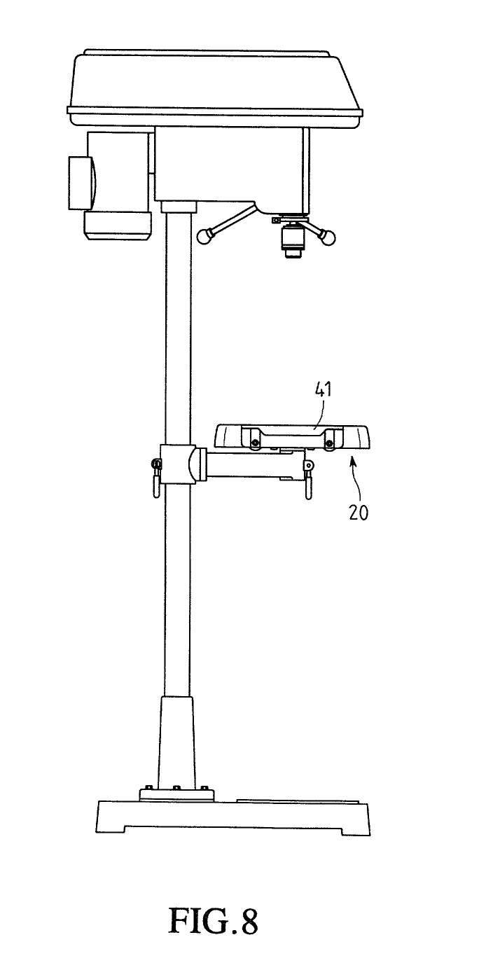

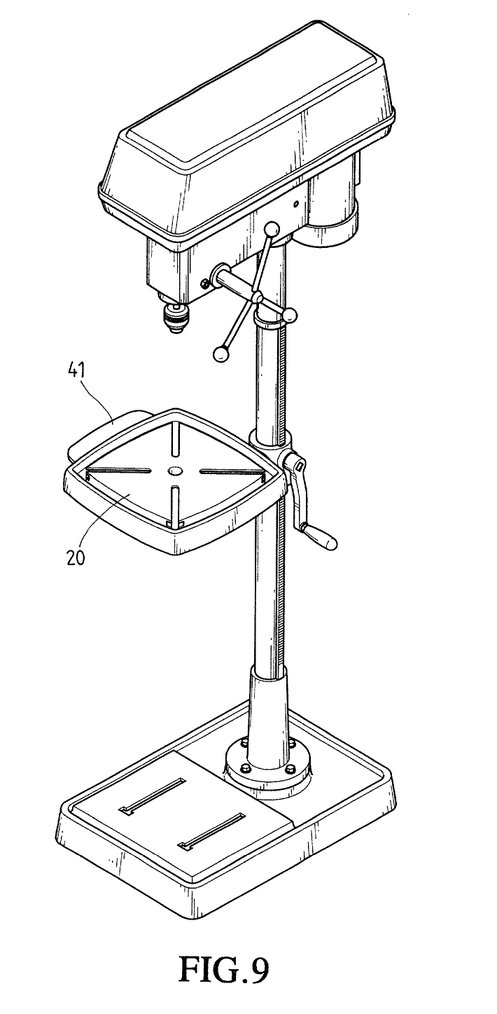

Referring to FIGS. 2, 3, 8 and 9, the bench assembly of the present invention comprises a main bench 20 connected to a post of a drilling machine and a peripheral flange 21 extends from the main bench 20. Two recesses 210 are defined in the peripheral flange 21 and a retaining member 30 is connected to an underside of the main bench 20. Further referring to FIG. 6, a lock member 32 extends through the retaining member 30 and is connected to a protrusion 22 on the underside of the main bench 20. The retaining member 30 has two grooves 31 defined in two ends thereof.

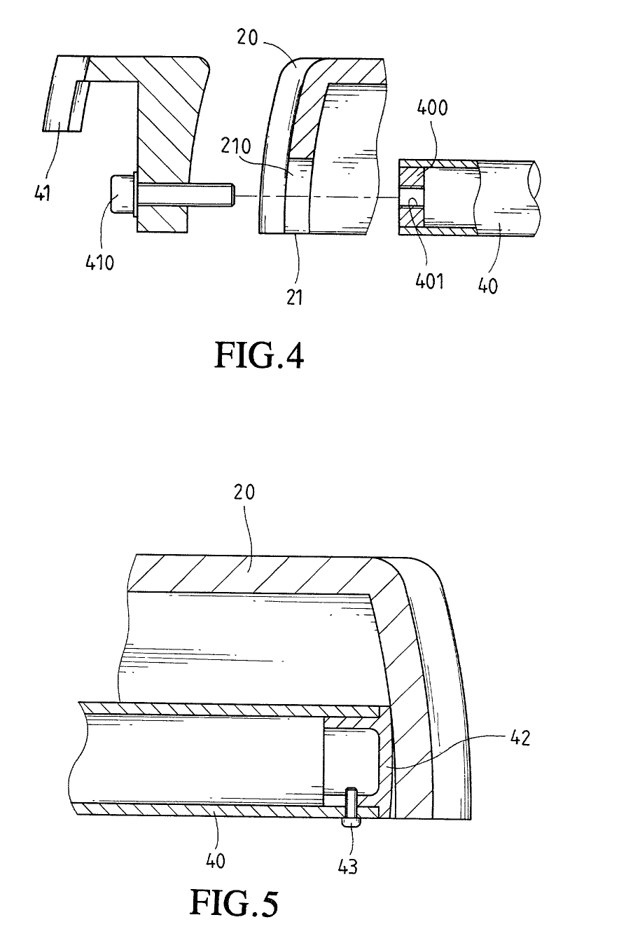

An auxiliary bench comprises two rods 40 which are engaged with the two recesses 210 in the peripheral flange 21 and movably received in the two grooves 31 in the retaining member 30. As shown in FIG. 4, each of the rods 40 has an end plate 400 connected to a first end thereof and the end plate 400 has a threaded hole 401 defined therein. A handle 41 is connected to the two rods 40 by extending a bolt 410 through the handle 41 and engaged with the threaded hole 401. As shown in FIG. 5, each of the two rods 40 has a rubber end member 42 connected to a second end thereof so that the end members 42 contact the peripheral flange 21 of the main bench 20 in silence. A bolt 43 extends through each of the rods 40 and positions the end members 42 to the rods 40, and the bolt 43 prevents the rod 40 from being pulling out from the retaining member 30. When locking the lock member 32 tightly, the two rods 40 are urged firmly by the retaining member 30 toward the main bench 20 so that the rods 40 cannot be pulled. The auxiliary bench can be pulled by firstly loosening the lock member 32.

The auxiliary bench can be conveniently received in the underside of the main bench 20 and can be pulled out so that a long object is supported on the auxiliary bench.

While we have shown and described the embodiment in accordance with the present invention, it should be clear to those skilled in the art that further embodiments may be made without departing from the scope of the present invention.

What is claimed is:

1. A bench assembly for drilling machines, comprising:
a main bench adapted to be connected to a post of a drilling machine and a peripheral flange extending from said main bench, two recesses defined in said peripheral flange and a retaining member connected to an underside of said main bench, said retaining member having two grooves defined therein, and
an auxiliary bench comprising two rods which are engaged with said two recesses in said peripheral flange and movably received in said two grooves in said retaining member, a handle connected to said two rods.

2. The bench assembly as claimed in claim 1 further comprising a lock member extending through said retaining member and connected to said underside of said main bench.

3. The bench assembly as claimed in claim 1, wherein each of said two rods has an end member connected to an end thereof.

4. The bench assembly as claimed in claim 3 further comprising a bolt extending through each of said rods and positioning said end members to said rods.
